(19) United States
(12) Patent Application Publication
(10) Pub. No.: US 2004/0186611 A1
(43) Pub. Date: Sep. 23, 2004

(54) Universal method for identifying human body profiles

(76) Inventor: Kenneth Kuk-Kei Wang, Hong Kong (CN)

Correspondence Address: William H Holt, Law Office of William H Holt, First Floor Unit 2, 1423 Powhatan Street, Alexandria, VA, 22314, US

(21) Appl. No.: 10/477,323

(22) PCT Filed: May 11, 2001
(86) PCT No.: PCT/EP01/05480

(51) Int. Cl. G06F 19/00

(52) U.S. Cl. 700/132

(57) ABSTRACT

Process for identifying human body profiles of the type comprising:

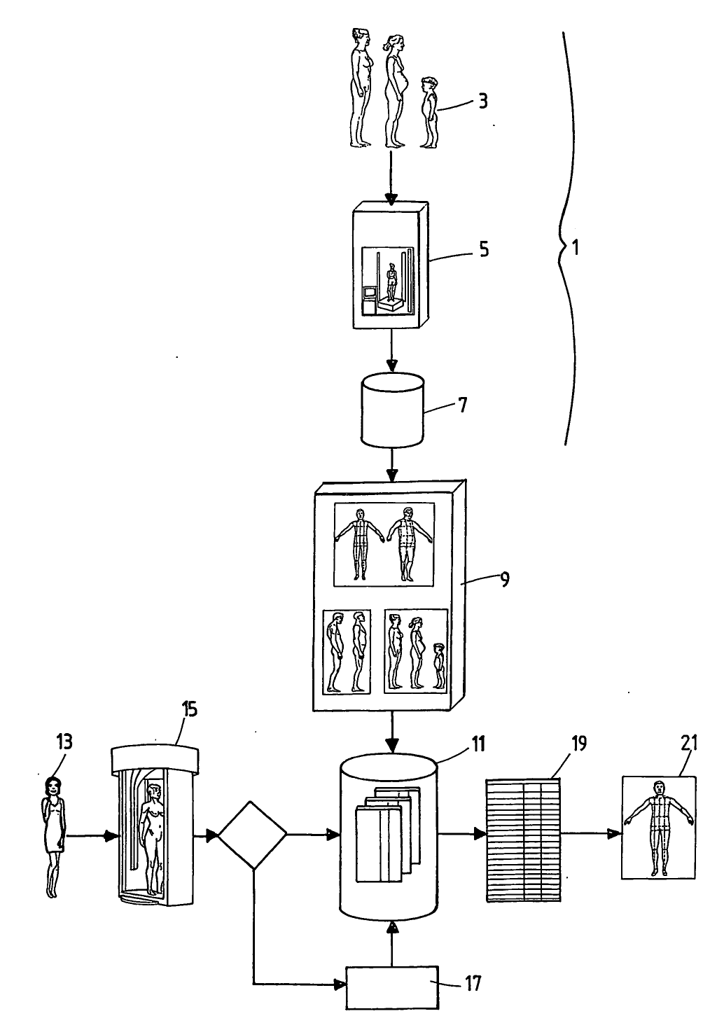

a) the preliminary steps consisting of:

a1) importing (1) morphological data originating from the three-dimensional digitisation of the bodies either of a target population (3) or of live models regarded as representative of a given target,

a2) organising (9) and storing the morphological data according to previously defined key volumetric, dimensional, and angular criteria, thus constituting a database of human body profile types (11), and

b) the final step consisting of searching for and selecting from the database (11), within the tolerances which are acceptable for each of said key criteria, a suitable profile corresponding to the morphological data of the subject (13) under consideration recorded by means of a scanning booth (15), characterised in that the preliminary steps further comprise:

a3) recording categorising criteria of the target population (3) or models,

a4) organising and storing in said database said morphological data according to said categorising criteria in addition to organising said morphological data according to said key criteria,

and in that the final step further comprises selecting said appropriate profile, as a function of the categorising data of the subject (13).

### TECHNICAL FIELD OF THE INVENTION

The present invention relates to a process for identifying human body profiles.

### TECHNOLOGICAL BACKGROUND TO THE INVENTION

In a number of fields there is a need to obtain three-dimensional digital data representing the body of a subject under consideration (i.e. a real human body).

Such data may subsequently be used in particular to develop a virtual and/or real dummy body which is highly representative of the body of the subject under consideration.

The virtual dummy body can subsequently be used in connection with CAD systems (computer aided design/drawing).

As for the actual dummy body this may subsequently be used for the production, testing, and checking of actual size prototypes.

The use of dummy bodies of this kind takes on a particular importance in the field of clothing design but also in all other fields which require a faithful representation of the body of the subject under consideration in all its diversity.

For example, International Patent Application WO 01/01235 published on 4 Jan. 2001 in the name of T. Singhal illustrates the use of digital models to make it easier to purchase a garment. A virtual image of the customer wearing the garment of their choice is generated by a computer from measurements supplied by the customer.

Another way of obtaining digital data representing a person is to acquire images of this person and digitise (scan) them.

U.S. Pat. No. 5,530,652 published on 25 Jun. 1996 in the name of G. Croyle describes a process of this kind and the system based on a video camera which is adapted to carry it out. The process in question allows the morphological data of a target population to be entered into a database and to be organised according to volumetric, dimensional and angular criteria. This database makes it possible to produce standard patterns for different categories of garments.

European Patent Application EP-0.838.167 published on 29 April 1998 in the name of the company New Lady also describes a method of making clothes by recording and categorising live models. A virtual dummy which is as close as possible to the person who is to wear the garment is developed from the data recorded and from measurements resulting from the digitisation of the body of this person.

Up till now, the development of three-dimensional digital data representing the body of a subject under consideration required a “heavy” phase of digitising the body of this subject, allowing a very large number of points (typically several thousand) to be recorded.

Such digitisation involved the use of sophisticated and expensive equipment and took some time.

The present invention sets out to generate three-dimensional digital data representing the body of a subject under consideration, irrespective of their age, sex, and ethnic background, without the need for heavy digitisation.

### GENERAL DESCRIPTION OF THE INVENTION

This objective of the invention is achieved with a process for identifying human body profiles of the type of the processes known per se, comprising:

a) the preliminary steps consisting of:

a1) importing into an information processing system morphological data originating from the three-dimensional digitisation of the bodies either of a target population or of live models regarded as representative of a given target,

a2) organising and storing the morphological data in the information processing system according to previously defined volumetric, dimensional, and angular criteria, thus constituting a database of human body profile types, and

b) the final step consisting of searching for and selecting from the database, within the tolerances which are acceptable for each of the volumetric, dimensional, and angular criteria, a suitable profile corresponding to the morphological data of the subject under consideration recorded by means of a scanning booth.

Thanks to these general features of the process, in order to obtain three-dimensional digital data representing the body of a subject under consideration, it is sufficient according to the invention, in the course of the preliminary steps, to:

a3) record categorising criteria of the target population or dummies,

a4) organise and store in said database said morphological data according to said categorising criteria in addition to organising said morphological data according to said volumetric, dimensional, and angular criteria,

and, during the final step, select the appropriate profile as a function of the categorising data of the subject.

Most advantageously, the categorising data include at least the sex, age group, and ethnic background.

According to further features of the invention:

a search is carried out for the appropriate profile which is within the acceptable tolerances for each of the key criteria,

a new profile type is created if there is no suitable profile for the body of the subject under consideration,

the final step also comprises extracting, from the database, a complete table of measurements corresponding to the body of the subject under consideration,

this final step also comprises extracting from the database a full range of tables of measurements corresponding to the sliding scale of the range of sizes for this appropriate profile.

By proceeding according to all the above, “light” digitisation of the body of the subject under consideration is sufficient, i.e. digitisation in which a relatively small number of points are scanned.

For carrying out the process according to the invention a suitable apparatus is of the type comprising:

a data processing system having a database system,

means for three-dimensional scanning of the bodies either of a target population or of live models considered to be representative of a given target,

means for importing the morphological data generated by the scanning means into the data processing system,

means for organising the data in the data processing system according to predefined volumetric, dimensional, and angular criteria,

means for storing corresponding profile types in recordings of the database having volumetric, dimensional, and angular fields,

means for recording morphological data corresponding to a subject under consideration,

means for searching and selecting from the database, within acceptable tolerances for each of the volumetric, dimensional, and angular criteria, a suitable profile, corresponding to the data recorded.

The essential feature of the apparatus for identifying human body profiles according to the invention is that the recordings additionally have categorising fields.

There is an advantage to having categorising fields which include at least the sex, age group, and ethnic background.

In order to carry out light digitisation the apparatus according to the invention comprises recording means including a scanning booth which scans a small number of points on the subject's body.

The present invention also relates to the use of the above-mentioned process for generating a dummy body which is highly representative of the subject under consideration.

According to further features of this use:

the dummy body is real,

the dummy body is virtual,

the asymmetry of the dummy body is automatically corrected,

lines passing through key morphological points on the dummy body are drawn on this body,

the dummy body is suitable for garment design.

Further features and advantages of the invention will become apparent in the light of the description that follows and from studying the accompanying drawings.

### BRIEF DESCRIPTION OF THE DRAWINGS

The single FIGURE shows the main steps of the process according to the invention.

### DESCRIPTION OF PREFERRED EMBODIMENTS OF THE INVENTION

As is clear from the drawing, data obtained from a morphological population survey 3 are first collected (reference 1) using a three-dimensional scanning booth 5 (“3D scanner”) and the morphological data thus collected are stored in a database 7.

A survey of this kind may be general, systematic or sample-based but may also be narrowly targeted for the needs of a detailed knowledge of a specific class of individuals such as soldiers, school children, the customers of a particular chain store, of a particular catalogue, etc.

According to an alternative embodiment the bodies of live models regarded as representative of a given target are scanned.

Then, these data are organised (reference 9) into categories or “profiles” according to predefined key criteria such as:

1. categorising criteria: sex, age group, ethnic background;

2. volumetric criteria: weight, body mass index, size (chest-waist-hips) and, for women, the shape of the breasts (cup size/vertical-lateral positioning);

3. dimensional criteria: height and inside leg measurement (without shoes);

4. angular criteria: the shape of the shoulders (degree of slope, width) and deportment (degree of inclination of the upper body).

Thus at 11 a database of profile groups is obtained which can constantly be added to by the importing of new surveys or special studies.

In order to obtain three-dimensional digital data representing the body of a subject 13 under consideration, particularly with a view to generating a virtual or real dummy body, first of all the body of the subject under consideration is scanned in a “light” scanning booth 15 so as to take from the subject only the measurements corresponding to the key criteria mentioned above.

In computer aided clothes design, the subject under consideration may either be a “reference” model regarded by a particular stylist or designer as being particularly representative of a target group of customers or may be a specific customer wishing to buy from a shop equipped with a light scanning booth.

Once the measurements corresponding to the above-mentioned key criteria have been obtained a search is run in the profile database 11 to see whether there is a profile corresponding to this combination of measurements within acceptable tolerances for each of the key criteria.

If, taking account of these tolerances, no corresponding profile is found within the size in question, a new profile may be created within the database 11 and in this way it can be progressively built up (reference 17).

In every case, once the profile representing the body of the subject under consideration has been determined, a table 19 of measurements and parameters corresponding to this body and to each different sized body within the sliding scale can be extracted from the database 11.

A knowledge of this full range makes it possible, particularly in computer aided clothes design, to provide a certain model of garment intended for a targeted customer base in every size in the range.

Using the measurements and parameters thus obtained, a virtual dummy body 21 and/or an actual replica thereof (not shown) which are highly representative of the body of the subject 13 under consideration can then notably be produced using methods known per se.

Preferably, lines passing through key morphological points on the model bodies are provided on these bodies.

In the case of computer aided clothing design, in particular, these lines, commonly known as “red lines”, correspond to horizontal and vertical cutting planes and are intended to allow the garment to be constructed on the dummy body.

There is also the option of providing means for automatically correcting the asymmetry of the dummy body 21.

As can now be understood, in order to obtain three-dimensional digital data representative of the body of a subject under consideration, all that is required is to carry out a search through a pre-existing database, starting from a limited number of key criteria.

Thus, “light” scanning of the body of the subject under consideration is sufficient, i.e. scanning in which a relatively small number of points are scanned.

Such light scanning can be carried out using unsophisticated and hence inexpensive apparatus.

It will also be noted that the digital data used in the process according to the invention can easily be transmitted to any compatible system through a data network (of the Internet or Intranet type, for example) which constitutes a crucial aid for any professional working in any field closely connected with the human body.

This is true particularly of designers and manufacturers of articles of clothing who wish to produce specific clothes intended either for a customer base with a very narrowly targeted profile or simultaneously for different population groups with their own characteristics, with the intention of dressing them in the same style while giving them the same level of fit and comfort.

Of course, the present invention is not limited to the embodiment described and shown here which is provided as an illustration without being restrictive.

1. Process for identifying human body profiles of the type comprising:
a) the preliminary steps consisting of:
a1) importing (1) into an information processing system morphological data originating from the three-dimensional digitisation of the bodies either of a target population (3) or of live models regarded as representative of a given target,
a2) organising (9) and storing the morphological data in the information processing system according to previously defined volumetric, dimensional, and angular criteria, thus constituting a database of human body profile types (11), and
b) the final step consisting of searching for and selecting from the database (11), within the tolerances which are acceptable for each of the volumetric, dimensional, and angular criteria, a suitable profile corresponding to the morphological data of the subject (13) under consideration recorded by means of a scanning booth (15), characterised in that the preliminary steps further comprise:
a3) recording categorising criteria of the target population (3) or models,
a4) organising and storing in said database said morphological data according to said categorising criteria in addition to organising said morphological data according to said volumetric, dimensional, and angular criteria,
and in that the final step further comprises selecting said appropriate profile, as a function of the categorising data of the subject (13).

2. Process according to claim 1, characterised in that the categorising data comprise at least the sex, age group, and ethnic background.

3. Process according to any one of claims 1 and 2, characterised in that a new profile type (17) is created when no profile adapted to the body of the subject (13) under consideration is found.

4. Process according to one of claims 1 and 3, characterised in that the final step comprises extracting from said database (11) a complete table of measurements (19) corresponding to the body of the subject under consideration (13).

5. Process according to any one of claims 1 to 4, characterised in that the final step comprises extracting from said database (11) a complete range of tables of measurements corresponding to the sliding scale of the range of sizes for said suitable profile.

6. Apparatus for identifying human body profiles suitable for carrying out the process according to any one of claims 1 to 5, of the type comprising:
an information processing system comprising a database system (11),
means (5) for three-dimensional scanning of the bodies either of a target population (3) or of live models regarded as representative of a given target,
means for importing the morphological data generated by the scanning means into the information processing system,
means for organising the data in the data processing system according to predefined volumetric, dimensional and angular criteria,
means for storing corresponding profile types in recordings of the database (11) having volumetric, dimensional and angular fields,
means for recording (15) morphological data corresponding to a subject (13) under consideration,
means for searching and selecting from the database (11), within acceptable tolerances for each of the volumetric, dimensional, and angular criteria, a suitable profile, corresponding to the data recorded,
characterised in that the recordings further include categorising fields.

7. Apparatus according to claim 6, characterised in that said categorising fields include at least the sex, age group, and ethnic background.

8. Apparatus according to any one of claims 6 and 7, characterised in that said recording means comprise a light scanning booth (15) which records a small number of points on the body of said subject (13).

9. Use of the process for identifying human body profiles according to any one of the preceding claims in order to generate a dummy body (21) which is highly representative of the subject under consideration (13).

10. Use according to claim 9, wherein said dummy body (21) is real.

11. Use according to claim 9, wherein said dummy body (21) is virtual.

12. Use according to one of claims 9 to 11, wherein the asymmetry of said dummy body (21) is automatically corrected.

13. Use according to any one of claims 9 to 12, wherein lines passing through key morphological points on the dummy body (21) are drawn on the body.

14. Use according to any one of claims 9 to 13, wherein said dummy body (21) is adapted for the design of garments.
